(19) United States
(12) Patent Application Publication
(10) Pub. No.: US 2010/0167652 A1
(43) Pub. Date: Jul. 1, 2010

(54) COMMUNICATION DEVICE AND COMMUNICATION METHOD THEREOF

(75) Inventor: Fu-Yu Hsu, Keelung City (TW)

Correspondence Address: RABIN & Berdo, PC, 1101 14TH STREET, NW, SUITE 500, WASHINGTON, DC, 20005, US

(73) Assignee: Alpha Imaging Technology Corp., Hsinchu County (TW)

(21) Appl. No.: 12/613,609

(22) Filed: Nov. 6, 2009

(30) Foreign Application Priority Data
Dec. 31, 2008 (TW) 97151841

(51) Int. Cl. H04B 7/00; H04B 1/38

(52) U.S. Cl. 455/41.3; 455/557

(57) ABSTRACT

A communication device and a communication method thereof are provided. The communication device includes a communication chip, a host processor, an audio processor, and a switch. The host processor includes a communication protocol module and a headset profile module. The audio processor includes an audio profile module. The communication protocol module supports a communication protocol including a headset profile, an audio profile and more profiles. The communication protocol module forms a first connection with a wireless headset. The headset profile module supports the headset profile. The audio profile module supports the audio profile. The switch selectively and electrically connects the communication chip to the host processor or the audio processor. When the audio processor executes a music play procedure, the communication protocol module suspends the first connection. After forming a second connection with the wireless headset, the audio profile module outputs a music package to the communication chip.

This application claims the benefit of Taiwan application Serial No. 97151841, filed Dec. 31, 2008, the subject matter of which is incorporated herein by reference.

### BACKGROUND OF THE INVENTION

1. Field of the Invention

The invention relates in general to a communication device and a communication method thereof, and more particularly to a communication device with low power consumption and a communication method thereof.

2. Description of the Related Art

In the modern society where technology continually advances and improves, portable digital products such as mobile phones and PDA have become very popular communication devices. When receiving a call with a mobile phone, if the mobile phone is combined with a wireless headset, the user can communicate with the caller through the wireless headset without having to pick up the mobile phone. Also, when listening to the music or the broadcasting with the wireless headset, the user is not subjected to the wiring of a traditional headset.

FIG. 1 shows a block diagram of a communication device and a wireless headset of a traditional mobile phone. Referring to FIG. 1, the communication device 100A of a traditional mobile phone includes a communication chip 30A, a host processor 50A, and an audio processor 70A. The host processor 50A includes a communication protocol module 52A. The audio processor 70A performs data transmission with the host processor 50A by the bus A1. The communication chip 30A performs data transmission with the host processor 50A by the bus A2. When the user listens to the music through a wireless headset 90A of a traditional mobile phone, the audio processor 70A transmits the music package to the host processor 50A through the bus A1, and then the communication protocol module 52A of the host processor 50A transmits the music package to the communication chip 30A through the bus A2 to establish a connection with a wireless headset 90A.

However, when the traditional mobile phone plays music through the wireless headset 90A, the communication protocol module 52A of the host processor 50A, the audio processor 70A and the communication chip 30A must operate at the same time, so as to largely increase the power consumption of the traditional mobile phone. Thus, how to reduce the power consumption of the mobile phone without affect its performance has become a focus to the communication industry.

### SUMMARY OF THE DISCLOSURE

The disclosure relates to a communication device and a communication method thereof capable of reducing power consumption for the communication device.

According to a first aspect of the present invention, a communication method used in a communication device is provided. The communication device includes a communication chip, a host processor, an audio processor, and a switch. The host processor includes a communication protocol module and a headset profile module. The audio processor includes an audio profile module. The communication protocol module supports a communication protocol, which includes a headset profile, an audio profile and more profiles. The communication protocol module and a wireless headset establish a first connection. The headset profile module supports the headset profile. The audio profile module supports the audio profile. The switch is used for selectively and electrically connecting the communication chip to the host processor or the audio processor. The communication method includes the following steps. Firstly, the communication protocol module disconnects the first connection when the audio processor executes a music play procedure. Next, the headset profile module and the wireless headset establish a second connection. After that, a music package is outputted to the communication chip by the audio profile module.

According to a second aspect of the present invention, a communication device is provided. The communication device includes a communication chip, a host processor, an audio processor, and a switch. The host processor includes a communication protocol module and a headset profile module. The audio processor includes an audio profile module. The communication protocol module supports a communication protocol, which includes a headset profile, an audio profile and more profiles. The communication protocol module and a wireless headset establish a first connection. The headset profile module supports the headset profile. The audio profile module supports the audio profile. The switch is used for selectively and electrically connecting the communication chip to the host processor or the audio processor.

Wherein, the communication protocol module disconnects the first connection when the audio processor executes a music play procedure, and the audio profile module outputs a music package to the communication chip after the headset profile module and the wireless headset establish a second connection.

The invention will become apparent from the following detailed description of the preferred but non-limiting embodiments. The following description is made with reference to the accompanying drawings.

### BRIEF DESCRIPTION OF THE DRAWINGS

FIG. 1 shows a block diagram of a communication device and a wireless headset of a traditional mobile phone;

FIG. 2 shows a block diagram of a communication device and a wireless headset according to a preferred embodiment of the invention;

FIG. 3 shows a flowchart of a communication method according to a preferred embodiment of the invention;

FIG. 4 shows a block diagram of the inside of a wireless headset and a communication device of FIG. 2;

FIG. 5 shows a clock diagram of the step S110 of FIG. 3 executing a music play procedure;

FIG. 6A shows the communication method of FIG. 3 further includes step S140.

FIG. 6B shows a clock diagram of the step S140 of FIG. 6A executing a music play procedure;

FIG. 7A shows the communication method of FIG. 3 further including steps S151, S152, S153 and S154;

FIG. 7B shows a clock diagram of the step S151 of FIG. 7A executing a music play procedure and executing the receiving procedure of the telephony transceiver procedure;

FIG. 7C shows the step S151 of FIG. 7A executing a music play procedure and executing the sending procedure of the telephony transceiver procedure;

FIG. 8A shows the communication method of FIG. 3 further including steps S210˜S240; and

FIG. 8B shows a clock diagram of the step S210 of FIG. 8A executing a file transmission procedure during the music play procedure.

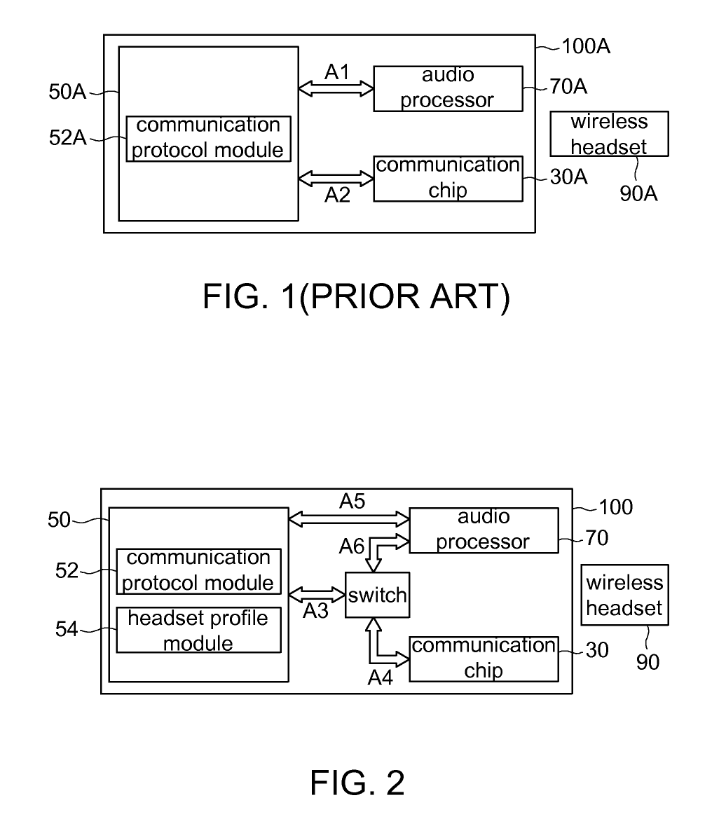

### DETAILED DESCRIPTION OF THE INVENTION

The invention provides a communication method used in a communication device. The communication device includes a communication chip, a host processor, an audio processor and a switch. The host processor includes a communication protocol module and a headset profile module. The audio processor includes an audio profile module. The communication protocol module supports a communication protocol, which includes a headset profile, an audio profile and more profiles. The communication protocol module and a wireless headset establish a first connection. The headset profile module supports the headset profile. The audio profile module supports the audio profile. The switch is used for selectively and electrically connecting the communication chip to the host processor or the audio processor. The communication method includes the following steps. Firstly, when a music play procedure is executed, the first connection is suspended. Next, a second connection is established. After that, the music package is outputted to the communication chip. The invention is exemplified by an embodiment below.

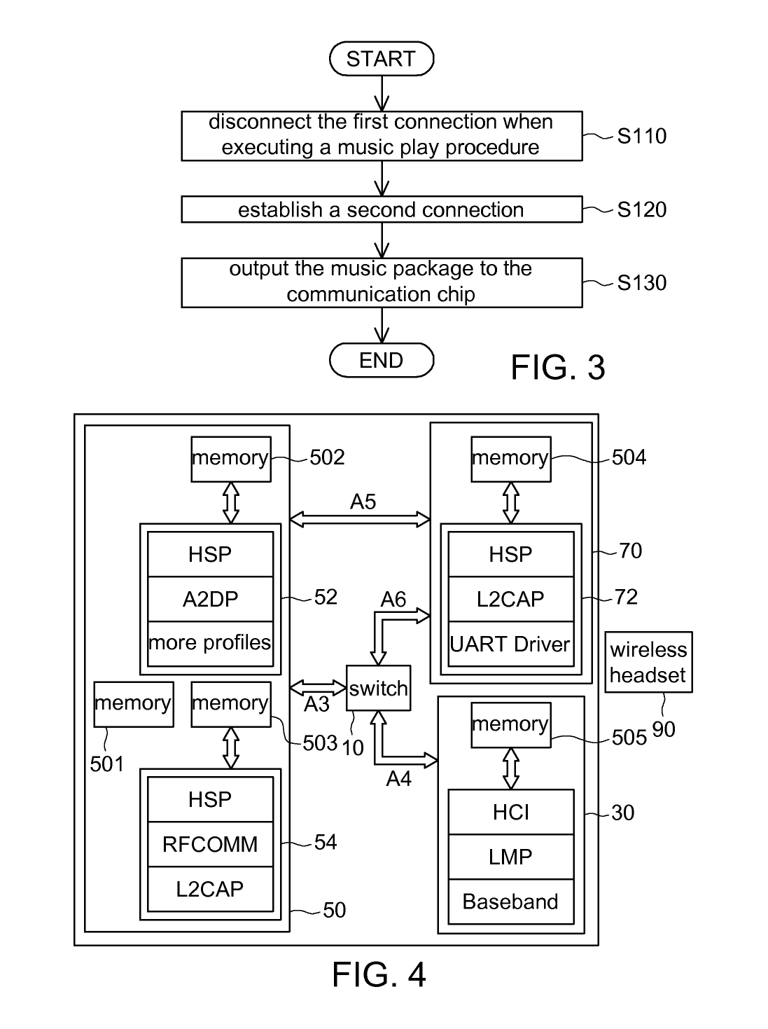

Referring to both FIG. 2 and FIG. 3. FIG. 2 shows a block diagram of a communication device and a wireless headset according to a preferred embodiment of the invention. FIG. 3 shows a flowchart of a communication method according to a preferred embodiment of the invention. The communication device 100 includes a communication chip 30, a host processor 50, an audio processor 70 and a switch 10. The host processor 50 includes a communication protocol module 52 and a headset profile module 54. The audio processor 70 includes an audio profile module 72. The communication protocol module 52 supports a communication protocol, which includes a headset profile, an audio profile and more profiles. The communication protocol module 52 and a wireless headset 90 establish a first connection. The headset profile module 54 supports the headset profile. The audio profile module 54 supports the audio profile. The switch 10 is used for selectively and electrically connecting the communication chip 30 to the host processor 50 or the audio processor 70.

Referring to both FIG. 2 and FIG. 3. The communication method can be used in the communication device 100 and includes the following steps. Firstly, the method begins at step S110, and the communication protocol module 52 disconnects the first connection when the audio processor 70 executes the music play procedure. Next, the method proceeds to step S120, the headset profile module 54 and a wireless headset 90 establish a second connection. After that, the method proceeds to step S130, the audio profile module 72 outputs a music package to the communication chip 30.

When the switch 10 electrically connects the audio processor 70 and the communication chip 30, the audio processor 70 communicates with the communication chip 30 through the buses A4 and A6. When the switch 10 electrically connects the host processor 50 and the communication chip 30, the host processor 50 communicates with the communication chip 30 through the buses A3 and A4. The buses A3, A4 and A6 are the buses supporting universal asynchronous receiver/transmitter (UART) signals for example, and the wireless headset 90 is a Bluetooth headset for example.

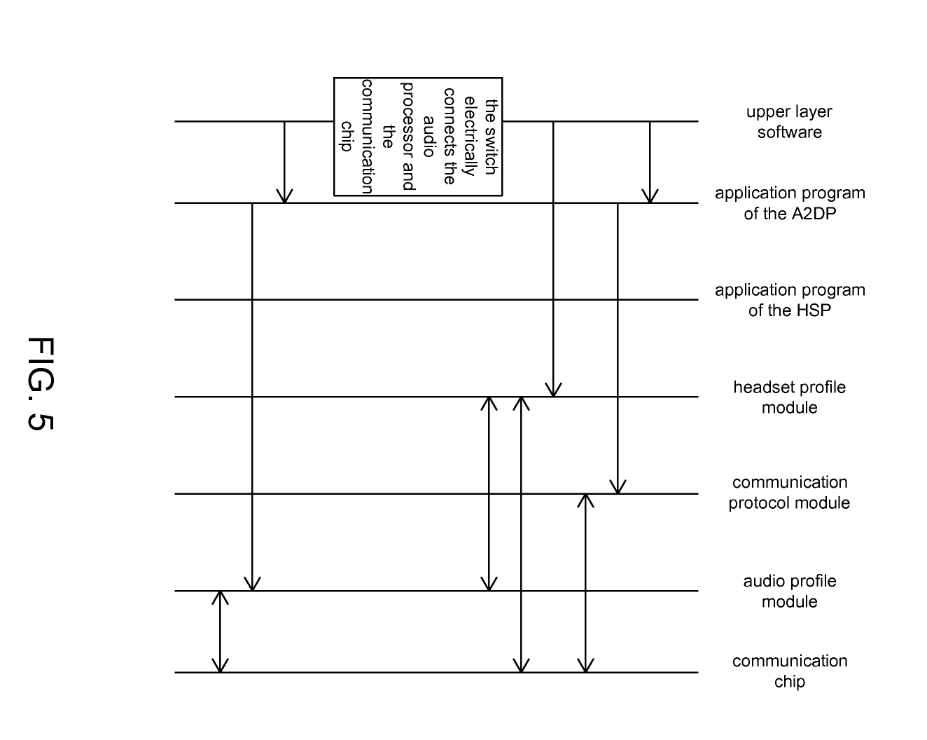

FIG. 4 shows a block diagram of the inside of a wireless headset and a communication device of FIG. 2. The host processor 50 further includes a memory 501, a memory 502 and a memory 503. The memory 501, used for storing the upper layer software of the host processor 50, supports the application programs of the headset profile and the audio profile. Preferably, the headset profile is a headset profile (HSP), and the audio profile is an advanced audio distribution profile (A2DP). The memory 502 of the host processor 50 is used for storing the application programs of the profiles supported by the communication protocol module 52. The memory 503 of the host processor 50 is used for storing the HSP, the radio frequency communication (RFCOMM) protocol, the logic link control and the adaptation protocol (L2CAP) which are supported by the headset profile module 54. The HSP enables the Bluetooth headset to communicate with the mobile phone, the computer, or other electronic product that has a Bluetooth device. The RFCOMM protocol simulates various applications of the serial port communication so that the conventional signal which is transmitted through the serial port communication such as the recommended standard 232 (RS-232) can be used directly. The L2CAP supports the multiplex transmission of data and the fragmentation and reassembly of data package.

As indicated in FIG. 4, the communication protocol module 52 supports the HSP, the A2DP and more profiles, and the headset profile module 54 supports the HSP. The headset profile module 54 is implemented by reading the HSP stored in the memory 503 by the micro-processor of the host processor 50. The RFCOMM protocol provides the serial port for simulating the L2CAP. The HSP fragments data package according to the L2CAP through the RFCOMM. However, the communication protocol module 52 can also implement the above functions.

The audio processor 70 further includes a memory 504 used for storing the A2DP. The audio profile module 72 of the audio processor 70 supports the A2DP. The audio profile module 72 is implemented by reading the A2DP stored in the memory 504 by the micro-processor of the audio processor 70. Data package is fragmentized according to the L2CAP, and the UART signal is converted by a UART driver.

The communication chip 30 further includes a memory 505 used for storing a host control interface (HCI), a link management protocol, (LMP) and a baseband. The HCI is designed by the Bluetooth Special Interest Group (SIG) for providing a software interface connected to a Bluetooth module. The LMP is used for managing the link and the control of the Bluetooth protocol. The baseband defines the frequency band operated at 2.4 GHz, and establishes a connection with a wireless headset by the frequency hopping technology used in wireless communication.

Referring to FIG. 3, FIG. 4 and FIG. 5. FIG. 5 shows a clock diagram of the step S110 of FIG. 3 executing a music play procedure. Firstly, the upper layer software of the host processor 50 informs the application program of the A2DP to request the communication protocol module 52 to disconnect the first connection with a wireless headset 90 through the communication chip 30. Next, the upper layer software of the host processor 50 informs the headset profile module 54 to establish a second connection with a wireless headset 90 through the communication chip 30. The headset profile module 54 and the audio profile module 72 perform data synchronization. After that, the switch 10 electrically connects the audio processor 70 and the communication chip 30, and the upper layer software informs the application program of the A2DP to request the audio profile module 72 to output a music package to the wireless headset 90 through the communication chip 30.

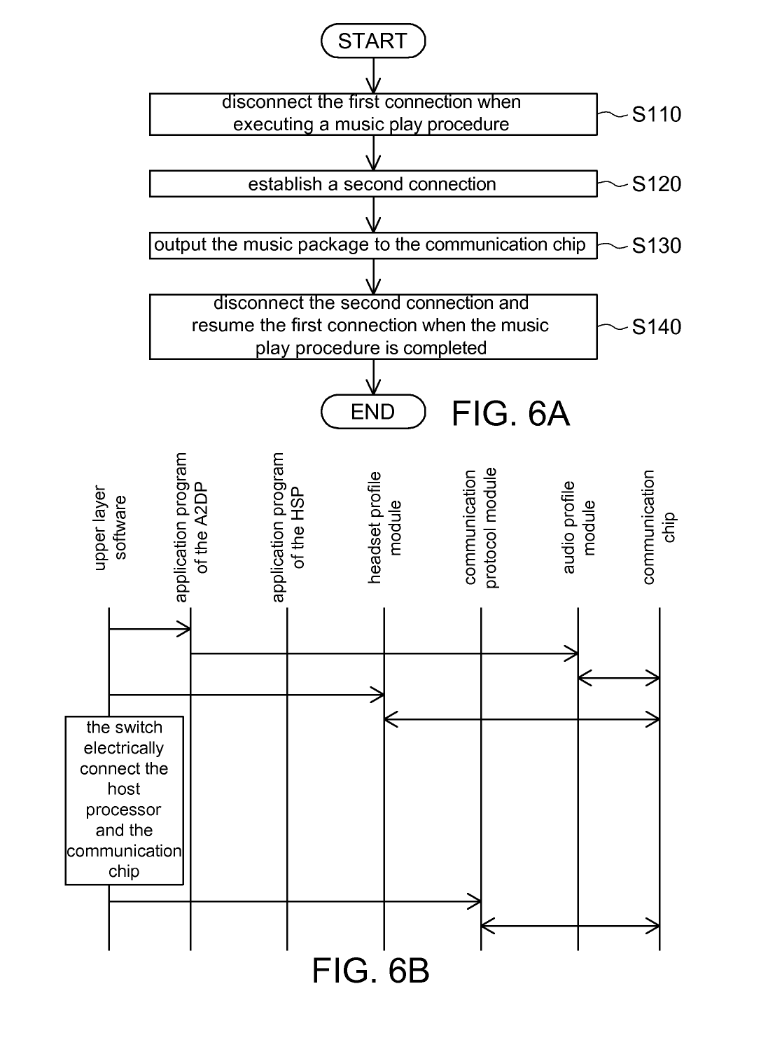

Referring to FIG. 3 and FIG. 6A. FIG. 6A shows the communication method of FIG. 3 further includes step S140. In step S140, when the music play procedure is completed, the second connection is disconnected and the first connection is resumed.

Referring to both FIG. 4, FIG. 6A and FIG. 6B. FIG. 6B shows a clock diagram of the step S140 of FIG. 6A executing a music play procedure. Firstly, the upper layer software of the host processor 50 informs the application program of the A2DP to request the audio profile module 72 to stop outputting the music package to the communication chip 30. Next, the upper layer software of the host processor 50 informs the headset profile module 54 to disconnect the second connection with a wireless headset 90 through the communication chip 30. After that, the switch 10 electrically connects the host processor 50 and the communication chip 30, and the upper layer software requests the communication protocol module 52 to resume the first connection with a wireless headset 90 through the communication chip 30.

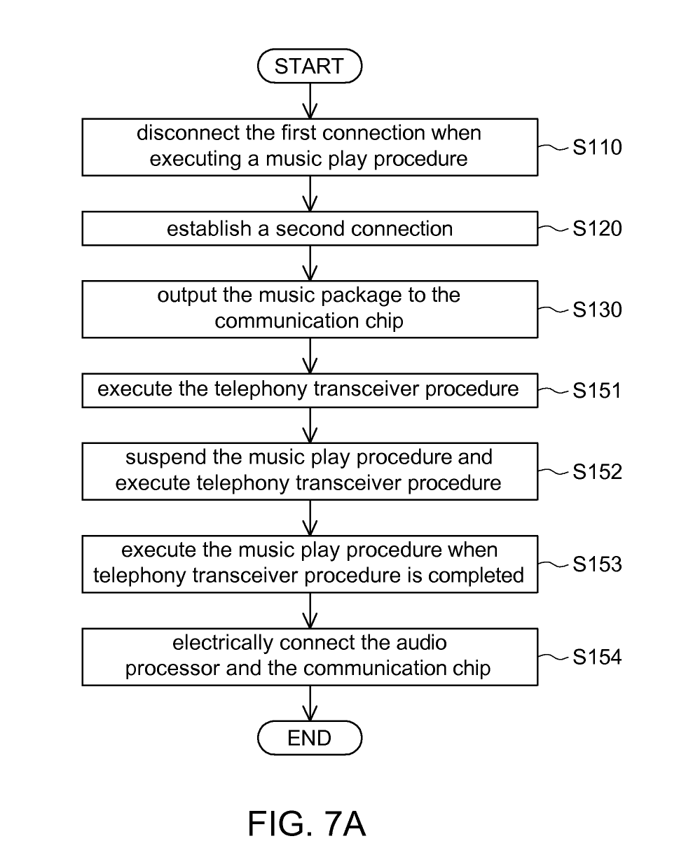

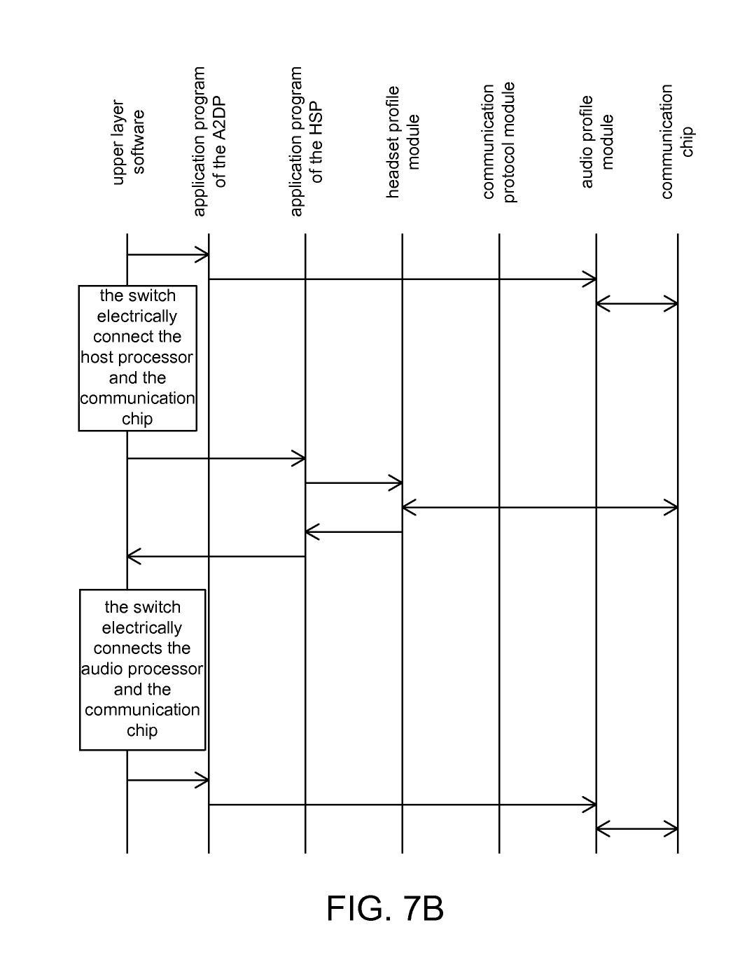

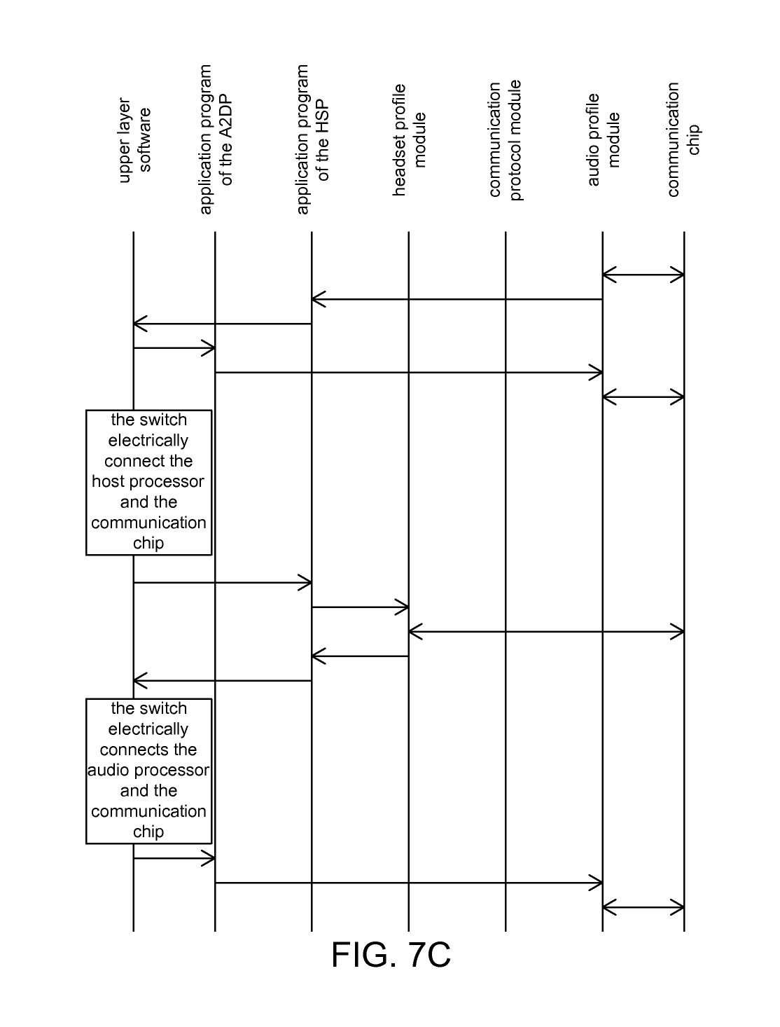

Referring to both FIG. 3 and FIG. 7A. FIG. 7A shows the communication method of FIG. 3 further including steps S151, S152, S153 and S154. In step S151, when the audio processor 70 executes the music play procedure, the telephony transceiver procedure is executed. In step S152, the music play procedure is suspended, and the telephony transceiver is executed. In step S153, when the telephony transceiver procedure is finished, the music play procedure is executed. In step S154, the switch 10 electrically connects the audio processor 70 and the communication chip 30. As indicated in step S151 of FIG. 7A, the telephony transceiver procedure includes a receiving procedure and a sending procedure elaborated below with accompanying drawings.

Referring to both FIG. 4, FIG. 7A and FIG. 7B. FIG. 7B shows a clock diagram of the step S151 of FIG. 7A when the music play procedure is executed the receiving procedure is executed. Firstly, the upper layer software informs the application program of the A2DP to request the audio profile module 72 to stop outputting the music package to the communication chip. Next, the switch 10 electrically connects the host processor 50 to the communication chip 30, and the upper layer software informs the application program of the HSP to request the headset profile module 54 to be connected to the wireless headset 90 through the communication chip 30. When the telephony transceiver procedure has been completed, the headset profile module 54, through the application program of the HSP, informs the upper layer software that the telephony transceiver procedure has been completed. After that, the switch 10 electrically connects the audio processor 70 and the communication chip 30, and the upper layer software informs the application software of the A2DP to request the audio profile module 72 to output the music package to the wireless headset 90 through the communication chip 30.

Referring to both FIG. 4, FIG. 7A and FIG. 7C. FIG. 7C shows the step S151 of FIG. 7A executing a music play procedure and executing the sending procedure of the telephony transceiver procedure. The audio profile module 72 requests the application program of the HSP to inform the upper layer software of the sending procedure event. Next, the upper layer software informs the application program of the A2DP to request the audio profile module 72 to stop outputting the music package to the communication chip 30. Next, the switch 10 electrically connects the host processor 50 and the communication chip 30, and the upper layer software informs the application program of the HSP to request the headset profile module 54 to be connected to the wireless headset 90 through the communication chip 30. When the sending procedure of the telephony transceiver is completed, the headset profile module 54 informs the upper layer software that the telephony transceiver has been completed through the application program of the HSP. Lastly, the switch 10 electrically connects the audio processor 70 to the communication chip 30, and the upper layer software informs the application software of A2DP to request the audio profile module 72 to output a music package to the wireless headset 90 through the communication chip 30.

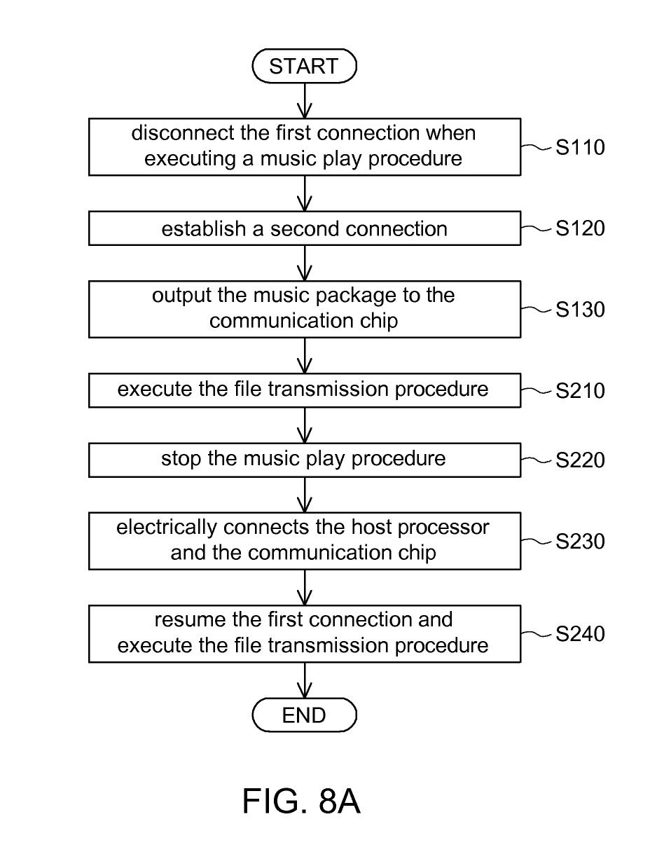

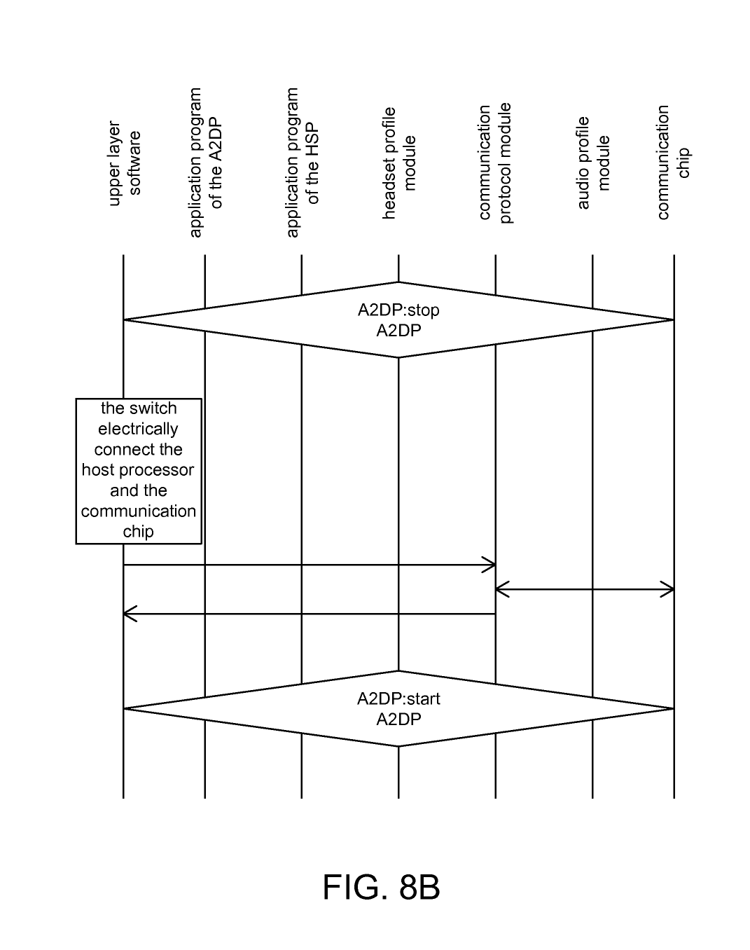

Referring to FIG. 8A, the communication method of FIG. 3 further including steps S210˜S240 is shown. In step S210, the file transmission procedure is executed. In step S220, the music play procedure is stopped. In step S230, the switch 10 electrically connects the host processor 50 and the communication chip 30. In step S240, the first connection is resumed and the file transmission procedure is executed.

Referring to both FIG. 4, FIG. 8A and FIG. 8B. FIG. 8B shows a clock diagram of the step S210 of FIG. 8A executing a file transmission procedure during the music play procedure. The connection relevant to the A2DP is disconnected. The upper layer software informs the communication protocol module 52 to resume the first connection with a wireless headset 90 through the communication chip 30. After that, when the file transmission procedure is finished, the communication protocol module 52 informs the upper layer software that the file transmission procedure has been completed, and the connections relevant to the A2DP are activated again. In the present embodiment of the invention, the audio processor supports the A2DP, and the communication protocol module supports the document transmission profile, the A2DP and the HSP. However, the audio processor may further support the audio/video distribution transport protocol (AVDTP), and the profiles supported by the communication protocol module are not limited to the above exemplifications.

Compared with the prior arts, the audio processor of the present embodiment of the invention supports the A2DP, and when the audio processor executes the music play procedure, the audio processor outputs a music package to the communication chip through the switch and establishes a connection with a wireless headset through the communication chip. Thus, the audio processor can execute the music play procedure without using the communication protocol module of the host processor. Thus, the communication protocol module of the host processor can enter a suspend mode during the execution of the music play procedure, hence reducing the power consumption of the communication device. When documents are transmitted during the music play procedure, the communication protocol module establishes a connection with the communication chip; meanwhile the audio processor can enter the suspend mode. Also, the headset profile module supports the HSP. During the execution of the music play procedure, if the telephony transceiver procedure is executed, the headset profile module establishes a connection with the communication chip, so that the communication protocol module can maintain in the suspend mode, hence reducing the power consumption of the communication device.

The communication device of the invention and the communication method thereof reduce the power consumption of the communication device, hence having high application and market competiveness.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A communication device, comprising:
a communication chip;
a host processor, comprising:
a communication protocol module supporting a communication protocol, which comprises a headset profile, an audio profile and a plurality of profiles, wherein the communication protocol module and a wireless headset establish a first connection; and
a headset profile module supporting the headset profile;
an audio processor, comprising:
an audio profile module supporting the audio profile; and
a switch for selectively and electrically connecting the communication chip to the host processor or the audio processor;
wherein the first the communication protocol module disconnects the first connection when the audio processor executes a music play procedure, and the audio profile module outputs the music package to the communication chip after the headset profile module and the wireless headset establish a second connection.

2. The communication device according to claim 1, wherein when the audio processor executes the music play procedure, the switch electrically connects the audio processor and the communication chip.

3. The communication device according to claim 1, wherein when the audio processor finishes the music play procedure, the second connection is disconnected and the first connection is resumed.

4. The communication device according to claim 3, wherein when the audio processor finishes the music play procedure, the switch electrically connects the host processor and the communication chip.

5. The communication device according to claim 1, wherein when the audio processor executes the music play procedure, if a telephony transceiver procedure needs to be executed the audio profile module suspends the music play procedure, and the headset profile module executes the telephony transceiver procedure.

6. The communication device according to claim 5, wherein when the audio processor executes the music play procedure, if the telephony transceiver procedure needs to be executed, the switch electrically connects the host processor and the communication chip.

7. The communication device according to claim 5, wherein when the telephony transceiver procedure is completed the audio profile module continues executing the music play procedure.

8. The communication device according to claim 5, wherein when the telephony transceiver procedure is completed, the switch electrically connects the audio processor and the communication chip.

9. The communication device according to claim 1, wherein when the audio processor executes the music play procedure, if a file transmission procedure needs to be executed the audio profile module suspends the music play procedure, and the communication protocol module resumes the first connection and executes the file transmission procedure.

10. The communication device according to claim 9, wherein when the file transmission procedure is executed, the switch electrically connects the host processor and the communication chip.

11. The communication device according to claim 1, wherein the headset profile is a headset profile (HSP).

12. The communication device according to claim 1, wherein the audio profile is an advanced audio distribution profile (A2DP).

13. The communication device according to claim 1, wherein the communication protocol is a Bluetooth profile.

14. A communication method used in a communication device for reducing consumption power, wherein the communication device comprises a communication chip, a host processor, an audio processor and a switch, the host processor comprises a communication protocol module and a headset profile module, the audio processor comprises an audio profile module, the communication protocol module supports a communication protocol, which comprises a headset profile, an audio profile and a plurality of profiles, the communication protocol module and a wireless headset establish a first connection, the headset profile module supports the headset profile, the audio profile module supports the audio profile, and the switch is used for selectively and electrically connecting the communication chip to the host processor or the audio processor,
the communication method comprises:
disconnecting the first connection when executing a music play procedure;
establishing a second connection; and
outputting the music package to the communication chip.

15. The communication method according to claim 14, wherein when executing the music play procedure, the audio processor electrically connects the communication chip.

16. The communication method according to claim 14, wherein when the music play procedure is completed, the second connection is disconnects and the first connection is resumed.

17. The communication method according to claim 16, wherein when the music play procedure finished, the host processor electrically connects the communication chip.

18. The communication method according to claim 14, wherein when executing the music play procedure, if a telephony transceiver procedure needs to be executed, the music play procedure is suspended, and the procedure of sending/receiving a call is executed.

19. The communication method according to claim 18, wherein during the execution the music play procedure, if the telephony transceiver procedure needs to be executed, the host processor electrically connects the communication chip.

20. The communication method according to claim 18, wherein when the telephony transceiver procedure is completed the audio profile module continues to execute the music play procedure.

21. The communication method according to claim 18, wherein when the telephony transceiver procedure is completed, the audio processor electrically connects the communication chip.

22. The communication method according to claim 14, wherein when executing the music play procedure, if a file transmission procedure needs to be executed, the music play procedure is suspended, the first connection is resumed and the file transmission procedure is executed.

23. The communication method according to claim 14, wherein when executing the file transmission procedure, the host processor electrically connects the communication chip.
